(19) United States
(12) Patent Application Publication
(10) Pub. No.: US 2007/0277378 A1
(43) Pub. Date: Dec. 6, 2007

(54) Surgical Claw Clippers

(76) Inventor: Klaus Kabella, Zernikow (DE)

Correspondence Address: BORDEN LADNER GERVAIS LLP;Gail C. Silver, 1100-100 QUEEN ST, OTTAWA, ON, K1P 1J9, CA

(21) Appl. No.: 10/598,588

(22) PCT Filed: Mar. 1, 2005
(86) PCT No.: PCT/DE05/00386

§ 371 Date: May 30, 2007

(30) Foreign Application Priority Data
Mar. 2, 2004 (DE) 10 2004 011 012.3

(51) Int. Cl. A01K 13/00

(52) U.S. Cl. 30/29; 30/233

(57) ABSTRACT

The aim of the invention is to avoid injury to blood vessels that are situated in claws, when cutting claws with claw clippers or scissors, in particular of dogs. To achieve this, a transilluminator (8) is provided on the claw clippers below the cutting opening (15), said device permitting a visual recognition of the course of blood vessels (18) immediately before the cut, so that the exact point of incision can be determined outside living cell tissue.

The invention relates to a surgical claw-cutting tool, such as claw clippers or claw scissors, for claw-trimming that is as painfree as possible.

### PRIOR ART

The cutting of claws, in particular in dogs, forms part of the indispensable care of animals. If it is not done, malformations and associated pain occur. If too much is cut off from the claw during trimming, however, the blood vessels located in the claw interior are injured. The animal suffers pain and bleeding. The inappropriate cuts are in most cases due to the fact that the course of the blood vessels cannot be discerned visually, in particular in dark claws.

Safety claw clippers for domestic animals which are intended to be capable of cutting off a claw in such a way that injury of the blood vessels in the claw is excluded are known from WO 02/051242 A1. For this purpose, the claw clippers have an insertion opening, the depth of which is varied by an adjusting bolt, the length of the claw piece to be cut off consequently being limited.

The disadvantage of this invention is that the adjustment of the claw piece to be cut off takes place by feeling and, if one does not wish to hit any blood vessels, too little rather than too much is cut off. As the course of the blood vessels can be very different, cutting off without injury is not excluded.

Furthermore, a claw cutter for clean and painfree cutting is described in patent specification U.S. Pat. No. 2,112,790.

In order not to hit any blood vessels when the claws are being cut, the description proposes holding the entire claw cutter with the claw against the light so that the blood vessels show through and are not injured during cutting.

This method is very awkward. In order to direct the light of the lamp onto the cutting location optimally, a number of hands are necessary, and accidental injury of the vessels is still not excluded.

### OBJECT OF THE INVENTION

It is an object of the invention to provide a surgical claw-cutting tool which permits visual discernment of the blood vessel course immediately before cutting, so that the exact cutting point can be fixed outside living cell tissue and cutting consequently takes place without pain.

The object is achieved with the features of patent claim 1. Advantageous developments and designs form the subject matter of the dependent claims.

The surgical claw-cutting tool consists of two shearing blades which can be moved toward one another in the manner of scissors or clippers by means of two handles and form a round or curved cutting opening. A transilluminator with lighting means, preferably high-intensity light-emitting diodes, is, firmly connected to a component of the claw-cutting tool, arranged below the cutting opening.

In this connection, the transilluminator transmits a light which can transilluminate a claw in such a way that the blood vessels located therein are clearly visibly discernible.

Lighting means of different light intensities and/or wavelengths can be used for differently pigmented claws.

The claw-cutting tool can be produced in various embodiments and designs as claw clippers or claw scissors. In this connection, the transilluminator is to be arranged on and fastened to the tool body in such a way that the lighting direction or beam direction is directed toward the cutting opening or as close as possible toward it. In this connection, it can be arranged below the cutting opening on the lower shearing blade or a special holding arrangement which is connected to the body of the clippers.

Bringing the light to the cutting opening by means of light guides is also conceivable.

It is furthermore advantageous to assign the transilluminator a sensor which is capable of detecting certain spectral wavelengths, for example that of hemoglobin. In this connection, the sensor is directed toward the light cone of the transilluminator and at the same time into the region of the cutting opening. On detection of the hemoglobin, the sensor emits an acoustic and/or optical signal and/or the shearing blades are locked.

For extremely accurate cutting and with regard to stationary transillumination, it is advantageous to guide the shearing blades or the legs which hold the shearing blades not on a circular path but parallel. In this case, the light transmitter (transilluminator) and the light receiver (sensor) are aligned accurately with one another. As both transmitter and receiver have a certain scattering cone, this is not absolutely necessary.

In a further development, a securing or clamping arrangement which secures the claw to be trimmed shortly before the cutting operation by light pressure on the handles is arranged on the claw-cutting tool. A subsequent, stronger pressure causes the elastic or resilient securing device to yield and the shearing blades to cut the claw off. For this purpose, the securing device is, depending on design and construction of the claw-cutting tool, arranged in front of or behind the shearing blades.

The geometrical design of the claw-cutting tool, whether as clippers or scissors for example, can vary in different variants and forms together with the transilluminator while maintaining functionality.

### EXAMPLES

The surgical claw-cutting tool is explained in greater detail in a preferred embodiment with reference to drawings, in which

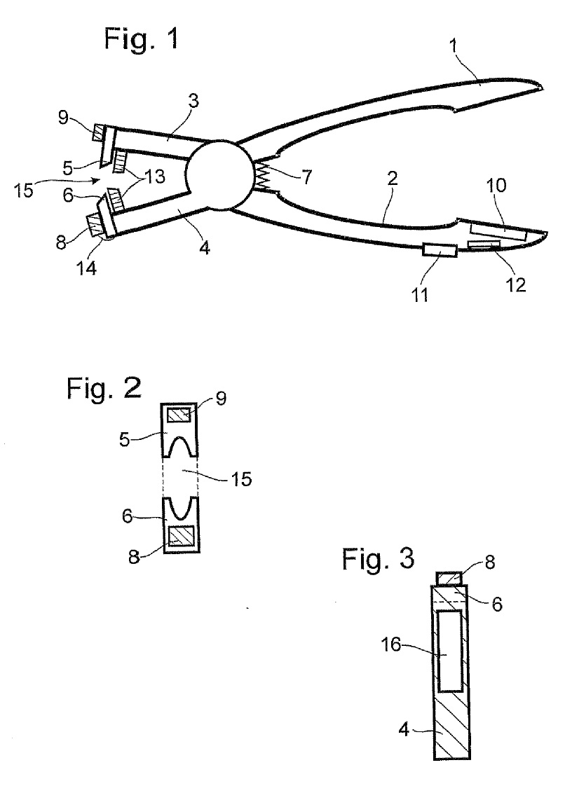

FIG. 1 shows the claw-cutting tool in the open state with a possible arrangement of transilluminator and sensor;

FIG. 2 shows an illustration of the cutting opening with the tool open according to FIG. 1;

FIG. 3 shows an illustration of the lower leg with a claw ejection opening, and

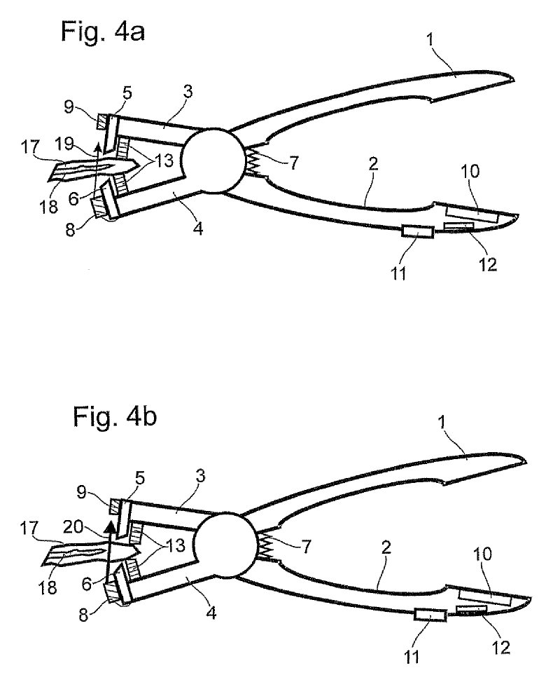

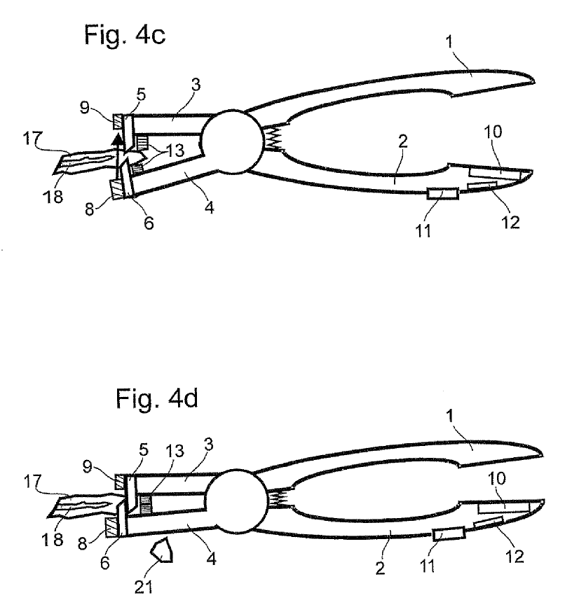

FIG. 4 show successive illustrations a, b, c and d which explain the cutting-off of a claw with the claw-cutting tool.

FIG. 1 illustrates a claw-cutting tool in the form of claw clippers with open shearing blades 5, 6 and consequently an open cutting opening 15 (see also FIG. 2). By pressing the handles 1, 2 together, the shearing blades 5, 6 are moved toward one another by means of two legs 3, 4 and the cutting opening 15 is closed. A spring 7 ensures that, when the pressure on the handles 1, 2 is reduced, the cutting opening 15 opens again automatically.

A transilluminator 8 is arranged below the cutting opening 15 on the lower shearing blade 6 or on a special holding arrangement. The basic body of the transilluminator 8 is fastened firmly, but preferably detachably, to the shearing blade 6 or to the lower leg 4.

The power supply for the transilluminator 8 is brought about by means of a power line 14 from a battery 10 located in the interior of a handle 2 and by means of an on/off switch 11. The power line 14 can of course also be run in a concealed way.

The transilluminator 8 is arranged below the cutting opening 15 in such a way that it does not impede the cutting operation but brings the light 19, 20 close to the cutting opening 15, and/or the light beam 19, 20 of the transilluminator 8 is directed at an angle toward the cutting opening 15. The transilluminator 8 is preferably fastened detachably for exchange.

The shape of the shearing blades 5, 6, the cutting opening 15 and the force transmission from the handles 1, 2 to the shearing blades 5, 6 is preferably selected in such a way that a claw 17 to be trimmed (illustrated in FIG. 4) is fixed before cutting by light manual pressure on the handles 1, 2, in order for it to be possible to control the exact cutting point safely.

As illustrated in FIG. 1 and FIG. 4, a securing device 13 in the form of a flexible body is preferably arranged behind the shearing blades 5, 6 for fixing the claw 17. The flexible bodies of the securing device 13 are in this embodiment fastened both at the top to the upper leg 3 and at the bottom to the lower leg 4 and dimensioned in such a way that, with light pressure on the handles 1, 2, the claw 17 is not yet caught by the shearing blades 5, 6 but is already held securely. A stronger pressure on the handles 1, 2 causes the flexible bodies 13 to yield and the shearing blades 5, 6 to bite into the claw 17 (see also FIG. 4).

In FIG. 1, a sensor 9, which measures the absorption of the light 19, 20, or detects the spectral wavelength of the red blood cells 18, is furthermore fastened to the upper shearing blade 5 opposite the transilluminator 8. The signal of the sensor 9 is emitted in a suitable way, here by means of a speaker 12. However, the cutting tool could also be locked if a blood vessel 18 is located in the region of the sensor 9.

The illustration in FIG. 2 shows the claw-cutting tool according to FIG. 1 with open shearing blades 5, 6 and insertion-ready cutting opening 15 from the front. The transilluminator 8 is arranged on the lower shearing blade 6, and the sensor 9 is located opposite it.

FIG. 3 shows the lower leg 4 of the claw-cutting tool with the lower shearing blade 6 and the transilluminator 8 seen from below. The lower leg 4 also has a cutout which serves as a claw ejection opening 16.

The diagrams a, b, c and d of FIG. 4 explain the functioning of the claw-cutting tool during cutting-off of a claw 17. In FIG. 4a, the claw 17 has been inserted too far into the cutting opening 15. The sensor 9 recognizes, for example owing to the higher absorption of the transmitted light 19, 20, illustrated here as a reduced light beam 19, or owing to a spectral change of the light 19, 20 of the transilluminator 8, that a blood vessel 18 has been detected. In this case, the speaker 12 emits a signal.

The flexible bodies 13 attached to the legs 3, 4, which serve as a securing device for the claw 17, fix the claw 17 and at the same time reduce the risk of unintentional premature cutting-off.

The cutting tool is then, as illustrated in FIG. 4b, pulled back until the light 19, 20 passes through the claw 17 unreduced (unreduced light beam 20). The claw 17 is now located in the correct position. Furthermore, the securing device 13 ensures that the claw 17 remains in this position and does not slip. With the transilluminator 8 switched on, it is also possible to monitor purely visually whether a blood vessel 18 is located in the beam path and consequently in the cutting opening 15.

Claw-cutting can then, as illustrated in FIG. 4c, be carried out at the correct place without injuring the blood vessel 18. The flexible bodies of the securing device 13, which are preferably made of rubber, are compressed during cutting, so that slight resistance has to be overcome in the process.

Lastly, FIG. 4d shows the cut claw 17 with the cut-off claw end 21, which has been ejected through the cutout 16 in the lower leg 4 by means of the flexible body 13.

### LIST OF REFERENCE NUMBERS

1 upper handle

2 lower handle

3 upper leg

4 lower leg

5 upper shearing blade

6 lower shearing blade

7 compression spring

8 transilluminator

9 optoelectronic sensor

10 battery compartment with electronics parts

11 on/off switch

12 speaker

13 flexible bodies, securing device

14 power line

15 cutting opening

16 claw ejector

17 claw

18 blood vessel

19 reduced light beam

20 unreduced light beam

21 cut-off claw end

1. A surgical claw-cutting tool comprising:
an upper and lower shearing blades disposed respectively on an upper and lower leg, said blades being movable towards one another in the manner of scissors or clippers by means of two handles and which blades form a round or curved cutting opening; and
a transilluminator with lighting means, disposed on the claw-cutting tool, below the cutting opening such that the light from the lighting means is directed toward the cutting opening.

2. The claw-cutting tool as claimed in claim 1, wherein the transilluminator is arranged on the lower shearing blade.

3. The claw-cutting tool as claimed in claim 1, further comprising light guides for bringing the light of the transilluminator to the cutting opening.

4. The claw-cutting tool as claimed in claim 1, wherein the transilluminator is made from a transparent material in which the lighting means are embedded.

5. The claw-cutting tool as claimed in claim 1 wherein the lighting means are light-emitting diodes.

6. The claw-cutting tool as claimed claim 1 further comprising a battery compartment and wherein the lighting means are connected by means of a power line via an on/off switch to the battery compartment.

7. The claw-cutting tool as claimed in claim 1, wherein different illumination intensities can be set for the lighting means.

8. The claw-cutting tool as claimed in claim 1, wherein the transilluminator comprises a sensor which detects the spectral wavelength of red blood cells and/or measures the absorption of the light.

9. The claw-cutting tool as claimed in claim 1, further comprising a securing device for securing a claw before a cutting operation.

10. The claw-cutting tool as claimed in claim 1 further comprising a claw ejection opening, disposed in the lower leg.

11. The claw-cutting tool as claimed in claim 6, wherein the battery compartment is arranged in one of the two handles.

12. The claw-cutting tool of claim 9, wherein the securing device is disposed adjacent to the shearing blades.
